(19) United States
(12) Patent Application Publication
(10) Pub. No.: US 2025/0296425 A1
(43) Pub. Date: Sep. 25, 2025

(54) Electric Motor Adapted to be Mounted in a Wheel of a Vehicle, and Braking System Thereof

(71) Applicant: Politecnico Di Torino, Torino (IT)

(72) Inventors: Massimiliana Carello, Torino (IT); Henrique De Carvalho Pinheiro, Torino (IT); Giovanni Imberti, San Benigno Canavese (IT)

(21) Appl. No.: 18/862,892

(22) PCT Filed: May 2, 2023
(86) PCT No.: PCT/IB2023/054549

§ 371 Date: Nov. 4, 2024

(30) Foreign Application Priority Data
May 5, 2022 (IT) 102022000009272

(51) Int. Cl. B60K 7/00; H02K 1/2791; H02K 7/102; H02K 21/22

(52) U.S. Cl. CPC B60K 7/0007; H02K 1/2791; H02K 7/1021; H02K 21/22; B60K 2007/0092

(57) ABSTRACT

An electric motor adapted to be mounted in a wheel of a vehicle includes: a stator provided with at least one winding; a rotor provided with at least one permanent magnet facing towards the at least one winding, wherein the rotor surrounds, at least partly, the stator and rotates around it; a braking system for slowing or stopping the motion of the rotor relative to the stator. The braking system further includes: a second stator enveloping at least one portion of the rotor and provided with a coil adapted to generate, when activated, a magnetic field; a magnetorheological fluid positioned in an air gap obtained between the second stator and the at least one portion of the rotor, wherein the magnetorheological fluid increases its viscosity when it is subjected to the magnetic field of the coil and exerts a braking force between the rotor and the second stator.

### BACKGROUND OF THE DISCLOSURE

### 1. The Field of the Disclosure

The present invention relates to an electric motor adapted to be mounted in a wheel of a vehicle and to a braking system of said electric motor.

In this frame, the present invention finds application in the field of electric motors known as “in-wheel” or “in-hub” motors, which can be used in electric or hybrid cars as well as other electric vehicles.

### 2. The Relevant Technology

It is known in the art that one of the most demanding and interesting challenges in the world of modern vehicles is to lower the vehicles' emissions of carbon dioxide (CO₂), nitrogen oxides (NOₓ) and particulate matter. In this regard, the introduction of electric vehicles on the market aims at eliminating the local emissions of internal combustion engines; however, as will be further explained below, with the solutions currently known in the art this goal can be achieved only partially.

It is also known in the art that electric motors are much simpler and much smaller than traditional engines; this leads to remarkable opportunities to increase and better exploit the available room aboard a vehicle, so that future electric vehicles, and particularly electric cars, can be made increasingly compact while still remaining very usable.

Some solutions are also known in the art which further enhance this advantage, such as mounting the electric motors directly in the wheels; such electric motors are known in the art as “in-wheel” (or “in-hub”) motors, wherein the electric motor is installed in the hub of a wheel to drive such wheel.

“In-wheel” electric motors offer several advantages compared with electric motors installed in the vehicle, in that “in-wheel” electric motors make it possible to further lighten the mechanical part of the vehicle and ensure a transmission of motion which is even more direct than can be obtained by in-vehicle electric motors.

Furthermore, “in-wheel” electric motors offer the possibility of obtaining much wider steering angles, due to the absence of axle shafts, as well as the additional and non-negligible possibility of improving the vehicle's safety and dynamic behaviour due to a lower centre of gravity and, most importantly, to the possibility of controlling the traction of each individual wheel of the vehicle.

The “in-wheel” motors that have been developed so far are so shaped that they can be inserted between a rotary member (usually consisting of a rim or a hub) and a fixed member (e.g., the hub carrier), and comprise a braking system which typically consists of a disk brake, i.e., a system comprising a caliper solidly connected to the vehicle and a disk solidly connected to the wheel, wherein the caliper defines a seat that houses brake pads, and wherein a mechanism pressurizes the brake fluid in order to press the pads against the disk, thereby generating a friction force (i.e., a braking action) countering the rotation of the wheel.

However, the “in-wheel” motors currently known in the art suffer from some drawbacks, which are mainly due to the coupling between the “in-wheel” electric motor and a disk-type braking system.

In this frame, and with a view to reducing the harmful emissions produced by the vehicle, it must be pointed out that in the vehicles currently known in the art, including also vehicles comprising at least one “in-wheel” electric motor, many pollutants are generated by the braking system; in particular, it has been recently highlighted that particulate matter and dust emissions are particularly abundant when braking is done by means of a disk brake.

The need is therefore apparent for implementing innovative solutions that can considerably reduce the pollution produced by the braking system of a vehicle, without however impairing the performance and intrinsic safety of such braking system.

Several technologies and solutions have been proposed in the art in an attempt to reduce the emissions of the braking system of a vehicle.

In this frame, a first solution envisages the use of alternative materials for the production of the pads of a disk brake, e.g., vegetable-base fibres suitable for replacing fibres from which particulate matter can be easily generated; nevertheless, it has been observed that this first solution can only reduce the amount of particulate matter emitted, without however completely eliminating it.

A second solution proposes the use of electromagnetic braking systems, e.g., eddy-current braking systems, Hall-effect braking systems, and hysteresis brakes. However, it has been observed that also this second solution suffers from some drawbacks, in that said electromagnetic braking systems do not provide a sufficiently high torque to be able to stop the vehicle in any driving condition, and sometimes cannot be geometrically implemented in a vehicle.

In general, the above-described solutions, as well as other solutions currently known in the art, have made it possible to obtain a reduction in the emissions of the braking system, without however being able to reach the goal of completely eliminating such emissions.

Furthermore, a disk-type braking system has response times due to the displacement of the brake fluid, which moves one or more pistons that press the pad against the disk, thereby slowing or stopping the vehicle. In this respect, the response of the brake fluid is not immediate, and the braking system suffers from a delay between the braking request issued by the driver and the actual activation of the disk brake, such delay being variable mostly as a function of the length of the brake line, and amounting to approx. 0.3 s. It is clear that such delayed response of the braking system inevitably translates into less safety of a vehicle equipped with a disk-type braking system.

### SUMMARY OF THE DISCLOSURE

In this frame, it is therefore the main object of the present invention to provide an electric motor adapted to be mounted in a wheel of a vehicle, wherein said electric motor is so realized as to comprise a braking system suitable to overcome the drawbacks of prior-art solutions.

In particular, it is one object of the present invention to provide an electric motor adapted to be mounted in a wheel of a vehicle and equipped with a braking system so conceived as to have zero emissions during every instant of any driving cycle, in particular without reducing the performance and intrinsic safety of the braking system.

It is another object of the present invention to propose an electric motor adapted to be mounted in a wheel of a vehicle, comprising a braking system so conceived as to avoid, or at least to limit, any delay in the response of said braking system, and to improve the intrinsic safety of the vehicle in whose wheels the electric motor is installed.

It is a further object of the present invention to propose an electric motor adapted to be mounted in a wheel of a vehicle and equipped with a braking system so realized as to produce a sufficiently high torque to be able to stop the vehicle in any driving condition.

It is yet another object of the present invention to propose an electric motor adapted to be mounted in a wheel of a vehicle and equipped with a braking system so conceived as to permit, or even facilitate, the geometric implementation of the assembly consisting of the electric motor and the braking system in a wheel of a vehicle.

### BRIEF DESCRIPTION OF THE DRAWINGS

Further objects, features and advantages of the present invention will become apparent in light of the following detailed description and the annexed drawings, which are provided herein merely by way of non-limiting explanatory example, wherein:

FIG. 1A shows a front view of an electric motor adapted to be mounted in a wheel of a vehicle and comprising a braking system realized in accordance with the present invention;

FIG. 1B shows a sectional view along line A-A of FIG. 1A;

FIG. 2 shows a detail of the electric motor shown in the sectional view of FIG. 1B;

FIG. 3 shows an exploded view of the motor and of the associated braking system according to the invention;

FIG. 4 shows a block diagram of one possible method of operation of the electric motor and of the associated braking system according to the invention.

### DETAILED DESCRIPTION OF THE PREFERRED EMBODIMENTS

Describing now the annexed drawings, reference numeral 1 designates as a whole an electric motor adapted to be mounted in a wheel of a vehicle in accordance with the present invention. It must be pointed out that the wheel and the vehicle are not shown in the annexed figures.

The motor 1 according to the present invention comprises:
a stator 10 provided with at least one winding 11;
a rotor 20 provided with at least one permanent magnet 21 facing towards said at least one winding 11, wherein said rotor 20 surrounds, at least partly, the stator 10 and rotates around it.

It is therefore clear that the motor 1 according to the present invention is of the external rotation type, since the rotor 20 is external to the stator 10 and rotates about it, and has no sliding electric contacts (i.e., the motor 1 is of the type known as “brushless”).

It should be noted that the stator 10 is adapted to be connected (whether directly or indirectly) to the fixed parts of the vehicle whereon the electric motor 1 is mounted; also, the stator 10 comprises a plurality of windings 11 extending radially from said stator 10, and the rotor 20 comprises a plurality of permanent magnets 21.

In the embodiment shown in the annexed figures, the rotor 20 comprises an external disk 20A and an internal disk 20B joined, at the distal ends thereof, by means of a ring 20C, wherein the permanent magnets 21 are associated with the inner face of the ring 20C and are positioned between the internal disk 20A and the external disk 20B.

In this context, the windings 11 extend radially from said stator 10 in the space comprised between the internal disk 20A and the external disk 20B of the rotor 20, facing towards the permanent magnets 21 of said rotor 20.

Furthermore, the motor 1 preferably comprises a hub 30 positioned inside the stator 10 and rigidly connected to the rotor 20, in particular said hub 30 being rigidly connected to the external disk 20B of said rotor 20; in this context, the motor 1 comprises at least one bearing 31 (or a technically equivalent element) interposed between the stator 10 and the hub 30 to reduce the friction between such components.

In an operating condition, i.e., in a condition wherein the motor 1 is mounted in a wheel of a vehicle, the external disk 20B of the rotor 20 faces towards the spokes of a rim of said wheel, while the internal disk 20A faces towards the fixed members of said vehicle; moreover, the hub 30 is rigidly constrained or connected to the rolling members of the vehicle, in particular to a hub of said vehicle.

It is nevertheless clear that the stator 10 and the rotor 20 (and possibly also the hub 30) may be implemented differently than shown in the annexed drawings; anyway, the stator 10 and the rotor 20 are implemented to create an external-rotation motor 1 (i.e., a configuration wherein the rotor 20 is external to the stator 10 and rotates around it).

The motor 1 comprises also a braking system for slowing or stopping the motion of the rotor 20 relative to the stator 10 (hence slowing or stopping the motion of a vehicle when the motor 1 is mounted in a wheel of said vehicle).

In accordance with the present invention, said braking system comprises a second stator 40 enveloping at least one portion of the rotor 20 and provided with a coil 41 adapted to generate, when activated, a magnetic field. It must be pointed out that the second stator 40 is connected (whether directly or indirectly) to the fixed parts of the vehicle whereon the motor 1 is installed.

Said braking system further comprises a magnetorheological fluid positioned in an air gap 42 obtained between the second stator 40 and said at least one portion of the rotor 20, wherein said magnetorheological fluid increases its viscosity (in particular, to the point of becoming a viscoelastic solid) when it is subjected to the magnetic field of the coil 41, exerting a braking force between the rotor 20 and the second stator 40.

In accordance with the present invention, it is therefore clear that the rotor 20 advantageously acts both as the rotor of the motor 1 and as the rotor of the braking system; consequently (as will be further explained hereinafter), it is also clear that the increased viscosity of the magnetorheological fluid, when the latter is subjected to the magnetic field of the coil 41, makes it possible to configure the magnetorheological braking system of the present invention as a brake working “in parallel” with the one of the electric motor 1.

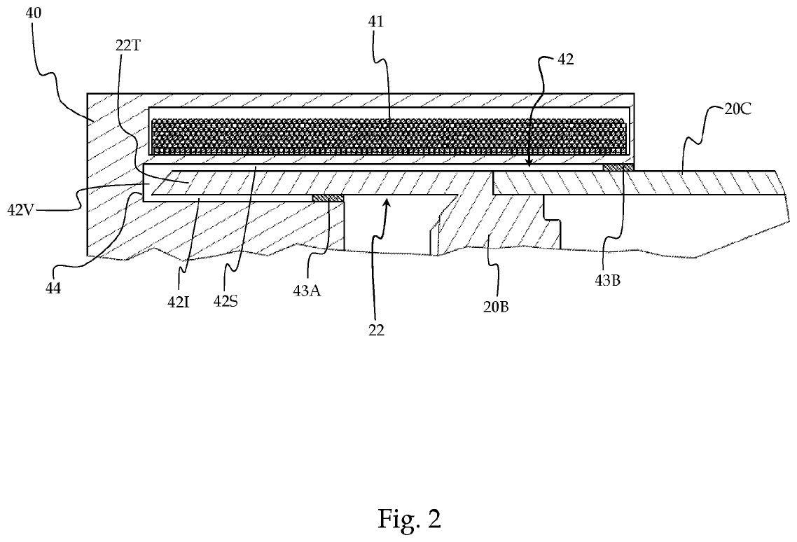

As particularly visible in FIG. 2, said air gap 42 is delimited by at least one sealing element 43A, 43B positioned between the second stator 40 and said at least one portion of the rotor 20; in particular, said at least one sealing element 43 preferably consists of a seal, in particular a lip seal.

Still with reference to FIG. 2, it can be noticed that said at least one portion of the rotor 20 comprises a protrusion (which may also be defined as a projection or an appendix) 22 of the rotor 20, in particular said protrusion 22 being so designed as to have a substantially annular or tubular shape.

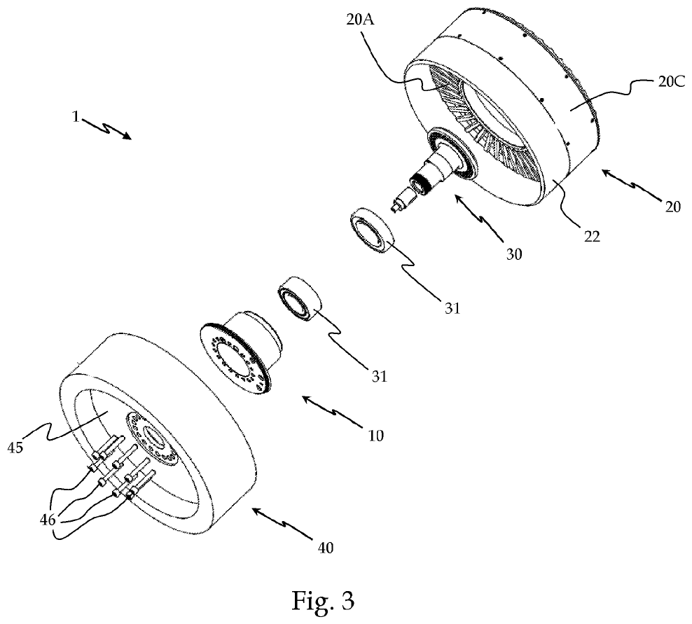

Preferably, said protrusion 22 is also so realized as to constitute an extension of the external ring 20C of the rotor 20; in fact, FIGS. 2 and 3 show that said protrusion 22 is so realized as to provide surface continuity with said external ring 20C of the rotor 20, in particular said surface continuity involving the external surfaces of both the ring 20C and the protrusion 22.

In this frame, the second stator 40 is preferably so realized as to comprise a recess (or concavity) 44 adapted to receive at least a terminal portion 22T of said protrusion 22 of the rotor 20, such that the air gap 42 and the magnetorheological fluid contained therein are so positioned as to surround (like some sort of vice) said terminal portion 22T of the protrusion 22.

In fact, as is particularly visible in FIG. 2, the terminal portion 22T of the protrusion 20 is positioned inside the recess 44 so as to create a substantially C-shaped air gap 42, i.e., with an upper tract 42S and a lower tract 42I mutually joined by a substantially vertical tract 42V.

Such provisions concerning the peculiar conformation of the air gap 42 (and also of the recess 44 that houses the terminal tract 22T of the protrusion 22) make it possible to optimize the braking torque exerted on the rotor 20 by the magnetorheological fluid, in that the latter can act upon both the inner portion of the protrusion 22 (i.e., that portion of the protrusion 22 which faces towards the centre of the motor 1 or towards the hub 30) and the outer portion of said protrusion 22 (i.e., that portion of the protrusion 22 which faces outwards from the hub 30). It should also be noted that the peculiar provisions of the protrusion 22, the recess 44 and the air gap 42 avoid the possibility that the activation of the coil 41 of the second stator 40 (which activation is necessary to activate the braking system of the invention) might interfere with the activation of the windings 11 of the stator 10 of the motor 1.

With the above-described geometry of the protrusion 22, air gap 42 and recess 44, the electric motor 1 according to the present invention comprises a first sealing element 43A positioned at the extremity of the lower tract 42I of the air gap 42 and a second sealing element 43B positioned at the extremity of the upper tract 42S of the air gap 42, wherein said sealing elements 43A, 43B preferably consist of a seal, in particular a lip seal.

In a preferred embodiment, said air gap 42 has a thickness in the range of 1 to 2 mm, preferably ca. 1.5 mm; this provision minimizes the rolling resistance of the vehicle when the magnetic field applied to the magnetorheological fluid by the coil 41 is null (i.e., no braking action), while maximizing the braking torque in the presence of a magnetic field applied to the magnetorheological fluid by the coil 41 (i.e., when braking). It should also be noted that the above-specified thickness of the air gap 42 has proved to be optimal also as concerns the inner temperature of the magnetorheological fluid, since it is of the utmost importance to keep such temperature within a certain range of values (in particular, at a temperature of less than approx. 140° C.) ensuring the proper operation of said magnetorheological fluid.

In a preferred embodiment, the surfaces of the rotor 20 and second stator 40 that face towards the air gap 42 are substantially smooth, i.e., with no reliefs, edges, protrusions or depressions visible to the naked eye.

Preferably, the protrusion 22 is made of ferromagnetic material, and so are, preferably, the other parts of the rotor 20; as concerns the second stator 40, it is made of paramagnetic material, e.g., aluminium. It must be pointed out that also the stator 10 is preferably made of paramagnetic material.

As previously explained herein, the second stator 40 is connected (whether directly or indirectly) to the fixed part of the vehicle whereon the motor 1 is installed; in accordance with the present invention, the second stator 40 of the braking system preferably comprises a discoid portion 45 connected to the stator 10 (which may then be defined as “first stator 10”) of the electric motor 1, in particular by fastening means 46, and said stator 10 is in turn connected to the fixed parts of the vehicle 1. It should be noted that in FIG. 3 said fastening means 46 are bolts; it is however clear that the first stator 10 (i.e., the stator 10 of the motor 1) and the second stator 40 may be mutually joined by different means, and also that such parts may be made as one piece. In this context, it is likewise evident that the increased viscosity of the magnetorheological fluid (when the latter is subjected to the magnetic field of the coil 41), in addition to exerting a braking force between the rotor 20 and the second stator 40, will also exert a braking force on the stator 10 of the motor 1 (since said stator 10 is integral with the second stator 40).

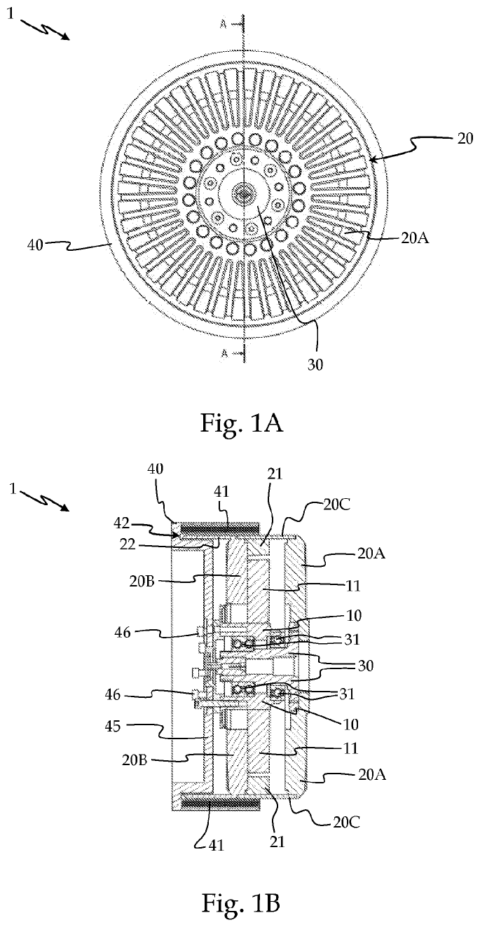

In FIGS. 1B and 3 one can also notice that the second stator 40 has, preferably, a flared conformation, in that the discoid portion 45 of the second stator 40 is lowered relative to the portion of the second stator 40 that comprises the recess 44. Advantageously, this limits the space occupied by the second stator 40 in the area where the electric motor 1 is to be connected to the fixed parts of the vehicle, in particular to the suspensions of said vehicle, because the lowered discoid portion 45 permits accommodating or housing at least a part of said fixed parts of the vehicle.

It should also be noted that the motor 1 according to the present invention is connected to a control unit of the vehicle whereon it is installed. Also, the motor 1 according to the present invention is electrically connected to at least one battery of said vehicle; in this regard, it should be noted that the motor 1 is of the type capable of providing regenerative braking, i.e., a braking action adapted to generate electric energy, which is then accumulated in said at least one battery.

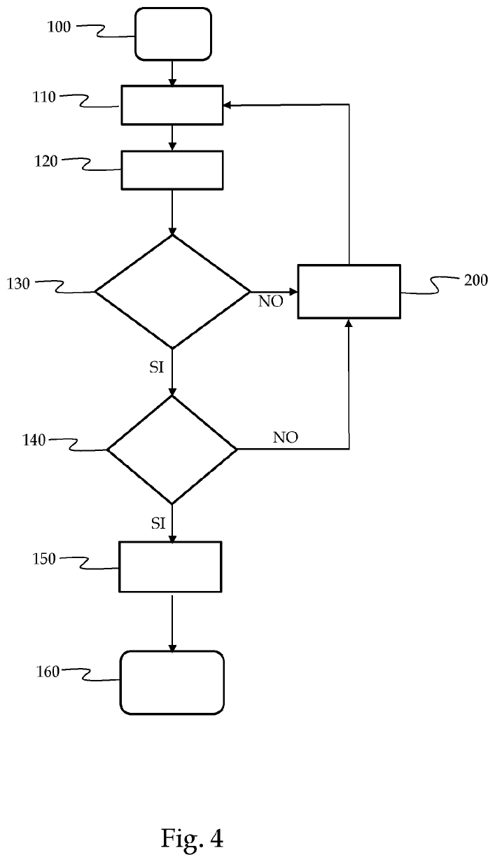

FIG. 4 shows a block diagram of one possible method of operation of the electric motor 1 and of the associated braking system according to the invention.

In this figure one can see that such method of operation comprises the following steps:
100 activating a braking signal by the vehicle driver;
110 making, by a control unit of the vehicle, an evaluation of the deceleration required by the braking signal activated by the driver;
120 activating, by the control unit of the vehicle, a braking action of the motor 1, in particular such braking action being a regenerative braking action and being obtained by inducing an electromotive force of the rotor 20 in the stator 10 to generate electric energy, which is then accumulated in at least one battery of the vehicle;
130 making, by the control unit of the vehicle, an evaluation as to whether or not the braking action of step 120 is sufficient to provide the required deceleration, in particular as a function of the evaluation made in step 110.

If the evaluation made in step 130 provides a negative response (i.e., if the braking action of step 120 is not sufficient to provide the required deceleration), then the method of operation of the electric motor 1 and of the associated braking system according to the present invention goes to a step 200 of activating, by the control unit of the vehicle, a coil 41 of a second stator 40 enveloping at least one portion of the rotor 20, wherein the activation of the coil 41 generates a magnetic field that increases the viscosity of a magnetorheological fluid positioned within an air gap 42 formed between the second stator 40 and said at least one portion of the rotor 20 to the point of becoming a viscoelastic solid and exerting a braking force between the rotor 20 and the second stator 40.

If the evaluation made in step 130 provides a positive response (i.e., if the braking action of step 120 is considered to be sufficient to provide the required deceleration), then the method of operation of the electric motor 1 and the associated braking system according to the present invention may include a step 140 of making, by the control unit of the vehicle, an evaluation of whether or not the state of charge (also referred to as “SoC”) of the vehicle is below a given operating threshold (e.g., 95%) for regenerative braking.

If the evaluation made in step 140 provides a negative response (i.e., if the state of charge of the vehicle is above a given operating threshold for regenerative braking, which thus cannot operate properly and fulfil the request from the vehicle driver), then the present method of operation includes a step 200 of activating, by the control unit of the vehicle, the coil 41 in order to generate a magnetic field that increases the viscosity of the magnetorheological fluid positioned in the air gap 42 to the point of becoming a viscoelastic solid exerting a braking force between the rotor 20 and the second stator 40.

If the evaluation made in step 140 provides a positive response (i.e., the state of charge of the vehicle is lower than a given operating threshold for regenerative braking, which can thus operate correctly), the present method of operation includes a step 150 of using solely a braking action of the motor 1 obtained by inducing an electromotive force of the rotor 20 in the stator 10.

The method of operation of the motor 1 and of the braking system according to the present invention further comprises a step 160 of terminating the braking operations.

The method of operation of the motor 1 and of the braking system according to the present invention envisages, therefore, that the braking actions of the electric motor 1 and of the magneto-rheological braking system occur in series.

In fact, so long as the deceleration request issued by the vehicle driver remains below the available regenerative braking limit, the braking function of the electric motor 1 will work autonomously; on the contrary, when said limit is exceeded, the magnetorheological braking system of the present invention will be activated to provide the braking torque necessary to meet the request issued by the vehicle driver. It must be pointed out that the activation of the magnetorheological braking system of the present invention also occurs when the control unit of the vehicle detects that the state of charge “SoC” is above the operating limit for regenerative braking.

Such provisions make it possible to overcome the problems that typically affect regenerative braking, i.e., the impossibility of bringing a vehicle to a complete halt by using only an electric motor known in the art, such problems being caused by two main situations:
the regenerative braking of an electric motor is physically limited to a maximum deceleration of 0.5 g. Consequently, limit braking (i.e., a value of approx. 0.9 g) can be provided by the magneto-rheological braking system of the present invention, which can supply the braking torque necessary to decelerate or stop the vehicle;
beyond a given value of the state of charge (“SoC”) regenerative braking loses intensity, resulting in less available deceleration. As a consequence, in such situations the magnetorheological braking system of the present invention (which can be considered as a brake working in “parallel” with the brake of the motor 1) is essential to obtain not only limit braking, but also more frequent braking operations (less than 0.4 g, but occurring within a short time interval).

The features of the motor 1 and of the associated braking system according to the present invention, as well as the advantages thereof, are apparent from the above description.

In fact, the provisions of the present invention make it possible to provide an electric motor 1 adapted to be mounted in a wheel of a vehicle (i.e., an “in-wheel” motor) comprising a magnetorheological braking system that substantially eliminates the vehicle's emissions during all drive cycles, in particular without reducing the performance and the intrinsic safety of the braking system; as a matter of fact, the magnetorheological braking system of the present invention does not emit any type of particulate matter when activated.

Another advantage of the solution according to the present invention comes from the fact that the magnetorheological braking system of the present invention has reaction times below 0.1 seconds, thanks to the instantaneous transfer of a current signal directly from the driver's foot to the coil 41 of the second stator 40, wherein the response and activation time of the magnetorheological fluid in the air gap 42 is nearly instantaneous.

It is therefore apparent that the provisions of the present invention make it possible to increase the safety of the vehicle on whose wheels the electric motor 1 of the present invention is installed, considering also that the remarkably shorter response time of the magnetorheological braking system translates into much more space available for safe braking, compared with the solutions currently known in the art.

A further advantage of the solution according to the present invention lies in the fact that the coupling between the magnetorheological braking system and the electric motor 1 of the present invention makes it possible to position the air gap 42 (i.e., the interface between the rotor 20 and the second stator 40, which contains the magnetorheological liquid) as far away as possible from the centre of rotation of the rotor 20, while still having a liquid-comprising portion which is sufficiently long for the braking action to occur. Due to these provisions, the resistant forces created by the magnetorheological liquid between the rotor 20 and the second stator 40 result in more torque, the force being equal to that obtained from a brake having the fluid more concentrated in the central region, due to a longer lever arm; indeed, the lever arm available in the solution of the present invention is the longest possible one, since it approaches the inner edge of the rim of the vehicle's wheel.

The combination of an in-wheel electric motor 1 and a magnetorheological braking system also permits exploiting the characteristics of the magnetorheological liquid and, consequently, maximizing the available braking torque.

Another advantage coming from the combination of the in-wheel electric motor 1 and the magnetorheological braking system lies in the fact that both components have the same working points in terms of temperature, which is a critical aspect for both the in-wheel motor 1 and the magnetorheological braking system, since both components must be kept below a limit temperature of 140° C. It is therefore evident that by combining the in-wheel electric motor 1 with the magnetorheological braking system of the present invention it is possible to solve the temperature problem through the use of a single cooling system in common to both the motor 1 and the associated braking system.

A further advantage resulting from the combination of the in-wheel electric motor 1 and the magnetorheological braking system lies in the fact that the set of connections of the motor 1 (i.e., the inlets and outlets for a cooling fluid, the electric connections, and the various connections to the fixed members of the vehicle) are already available from the motor 1 and can advantageously be used also for the magnetorheological braking system, thus obtaining a “plug-and-play” solution and making the solution of the present invention readily practicable.

In addition, the provisions of the present invention provide an advantageous activation in series of the braking actions of the electric motor 1 and of the magnetorheological braking system of the present invention, such activation in series making it possible to overcome the problems typically suffered by prior-art regenerative braking systems, such problems concerning the impossibility of stopping a vehicle through the sole use of an electric motor.

The motor 1 and the associated braking system described herein by way of example may be subject to many possible variations without departing from the novelty spirit of the inventive idea; it is also clear that in the practical implementation of the invention the illustrated details may have different shapes or be replaced with other technically equivalent elements.

It can therefore be easily understood that the present invention is not limited to the above- described motor 1 and associated braking system, but may be subject to many modifications, improvements or replacements of equivalent parts and elements without departing from the inventive idea, as clearly specified in the following claims.

1. An electric motor adapted to be mounted in a wheel of a vehicle, said motor comprising:
a stator provided with at least one winding;
a rotor provided with at least one permanent magnet facing towards said at least one winding, wherein said rotor surrounds, at least partly, the stator and rotates around it;
a braking system for slowing or stopping the motion of the rotor relative to the stator,
said braking system comprising:
a second stator enveloping at least one portion of the rotor and provided with a coil adapted to generate, when activated, a magnetic field;
a magnetorheological fluid positioned in an air gap obtained between the second stator and said at least one portion of the rotor, wherein said magnetorheological fluid increases its viscosity when it is subjected to the magnetic field of the coil and exerts a braking force between the rotor and the second stator.

2. The motor according to claim 1, wherein said air gap is delimited by at least one sealing element positioned between the second stator and said at least one portion of the rotor.

3. The motor according to claim 1, wherein said at least one portion of the rotor comprises a protrusion of said rotor.

4. The motor according to claim 3, wherein said protrusion is also so realized as to constitute an extension of an external ring of the rotor.

5. The motor according to claim 3, wherein the second stator comprises a recess adapted to receive at least a terminal portion of said protrusion of the rotor, such that the air gap and the magnetorheological fluid contained therein are so positioned as to surround said terminal portion of the protrusion.

6. The motor according to claim 5, wherein said terminal portion of the protrusion is positioned within the recess in such a way as to provide an air gap having an upper tract and a lower tract mutually joined by a substantially vertical tract.

7. The motor according to claim 6, comprising a first sealing element positioned at the extremity of the lower tract of the air gap and a second sealing element positioned at the extremity of the upper tract of the air gap.

8. The motor according to claim 1, wherein said air gap has a thickness in the range of 1 to 2 mm.

9. The motor according to claim 1, wherein the surfaces of the rotor and of the second stator that face towards the air gap are substantially smooth.

10. The motor according to claim 1, wherein the second stator of the braking system comprises a discoid portion connected to the stator of the electric motor.

11. The motor according to claim 10, wherein the second stator has a flared conformation, wherein the discoid portion of the second stator is lowered relative to the portion of the second stator that comprises the recess.

12. The motor according to claim 1, wherein the protrusion of the rotor is made of ferromagnetic material.

13. The motor according to claim 1, wherein the second stator is made of paramagnetic material.

14. A vehicle wheel comprising an electric motor according to claim 1.

15. A vehicle comprising at least one wheel in which the electric motor according to claim 1 is mounted.

16. The motor according to claim 2, wherein said at least one sealing element comprises a lip seal.

17. The motor according to claim 3, wherein said protrusion has a substantially annular or tubular shape.

18. The motor according to claim 4, wherein said protrusion provides surface continuity with said external ring of the rotor.
